(19) United States
(12) Patent Application Publication
(10) Pub. No.: US 2025/0263111 A1
(43) Pub. Date: Aug. 21, 2025

(54) METHOD FOR INDICATING A SET MOTOR TORQUE DETERMINING A CORRECTED SET MOTOR TORQUE VARYING WITH A CORRECTION FREQUENCY AROUND AN OPERATING VALUE

(71) Applicant: JTEKT EUROPE, Irigny (FR)

(72) Inventor: Jean-Michel TREBUCHON, Chasse sur Rhone (FR)

(73) Assignee: JTEKT EUROPE, Irigny (FR)

(21) Appl. No.: 19/057,476

(22) Filed: Feb. 19, 2025

(30) Foreign Application Priority Data
Feb. 19, 2024 (FR) 24/01599

(51) Int. Cl. B62D 5/04

(52) U.S. Cl. CPC B62D 5/0463

(57) ABSTRACT

A method determines a corrected set motor torque for a control motor of a power steering system without mechanical link, the control motor receiving the corrected set motor torque and exerting a motor torque on an axis of rotation including a steering wheel. The method includes: a step of receiving a set motor torque and a correction step in which the corrected set motor torque is determined based on a result of a comparison between the set motor torque and a normal operating threshold, the corrected set motor torque varying with a correction frequency around a corrected operating value over a corrected operating range, the corrected operating value being lower than the set motor torque.

### TECHNICAL FIELD

The invention concerns the field of power steering and more particularly a method for indicating a set motor torque, and a power steering without mechanical link implementing such a method.

### STATE OF THE PRIOR ART

A steering system of a vehicle is intended to enable a driver to control a trajectory of the vehicle by modifying an angle of orientation of the wheels of the vehicle by means of a steering wheel. The angle of orientation of the wheels is notably linked to an angle of the steering wheel, hereinafter referred to as “steering wheel angle”. The driver modifies the steering wheel angle by exerting a force on the steering wheel, hereinafter referred to as “steering wheel torque”.

Generally, a steering system comprises several elements including said steering wheel, a rack, and two wheels each connected to a connecting rod. The rack is the part used to maneuver the wheels, that is to say used to modify the angle of orientation of the wheels, via the connecting rods. The rack transforms a variation in the steering wheel angle into a variation in the vehicle's wheel angle.

In an electric power steering system without mechanical link, called “steer-by-wire”, the steering wheel is mechanically detached from the rack. In this case, the steering system comprises a steering wheel unit mechanically independent of a rack unit. In other words, a force applied to the steering wheel unit is not mechanically transmitted to the rack unit, and vice versa.

The rack unit comprises said rack and at least one electronic rack control unit which in particular pilots an angular position of the rack so that it is generally coherent with the steering wheel angle. Thus, the driver can steer the vehicle, that is to say modify the angular position of the rack, by means of the steering wheel. The electronic rack control unit comprises a maneuvering regulator which pilots a maneuvering motor which exerts a maneuvering motor torque on the rack. More precisely, the steering wheel angle is measured or calculated so as to determine a set maneuvering angle to be reached by the angular position of the rack. In other words, the maneuvering regulator slaves the angular position of the rack to the set maneuvering angle by piloting the maneuvering motor torque exerted by the maneuvering motor on the rack.

The steering wheel unit comprises said steering wheel and at least one electronic steering wheel control unit which determines in particular a torque to be felt by the driver during a steering wheel maneuver, hereinafter called the set motor torque. The set motor torque is intended in particular to make the driver feel torque information consistent with a life situation in which the vehicle is located (bending, straight line, level of grip, condition of the road surface, . . . ). The electronic steering wheel control unit comprises a control regulator which slaves the steering wheel torque to the set motor torque by means of a control motor. The control motor then exerts a motor torque on an axis of rotation of the steering wheel.

The set motor torque varies between a minimum value and a maximum value depending in particular on a maximum torque that can be provided by the control motor.

More specifically, the set motor torque varies mainly as a function of a vehicle travel speed, that is to say of the life situation of the vehicle, of a force acting between the wheels and a rolling surface, and of a rack position, in particular when the rack is in abutment. The rack comprises an abutment at each end. Said abutments may be physical abutments mechanically blocking the displacement of the rack or virtual abutments blocking the displacement of the rack by means of the maneuvering motor. The maximum value is requested in particular when the rack is in abutment, that is to say in a situation in which, in a power steering with a mechanical link between the steering wheel unit and the rack unit, the steering wheel can no longer turn.

As an illustration, it is assumed that the steering wheel is blocked in rotation for a set motor torque comprised between 30 Nm and 50 Nm. In other words, if the control motor exerts a torque comprised between 30 Nm and 50 Nm, the driver does not have enough force to turn the steering wheel.

There is a known solution in which the used control motor is a motor directly generating the motor torque on the axis of rotation of the steering wheel. This solution requires a control motor capable of generating a motor torque comprised between the minimum value and the maximum value of the set motor torque, that is to say a torque between 30 Nm and 50 Nm, driving a large motor. In addition, power electronics are required, which results in high current consumption and high electronic component prices.

There is also a solution in which the used control motor comprises a reducer, positioned between the motor and the axis of rotation of the steering wheel, allowing to generate a motor torque comprised between the minimum value and the maximum value of the set motor torque. For example, with a reducer of 20 and an efficiency of 90%, the maximum value of the set motor torque is 2.8 Nm. This solution requires a motor size smaller than the solution above but requires an additional mechanical part, the reducer, increasing a risk of failure.

There is therefore a need for a control motor with a reduced size and few mechanical parts.

### DISCLOSURE OF THE INVENTION

One embodiment concerns a method for indicating a set motor torque determining a corrected set motor torque for a control motor of an electric power steering without mechanical link, said control motor receiving the corrected set motor torque and exerting a motor torque on an axis of rotation comprising a steering wheel, said method being implemented by an electronic steering wheel control unit and comprising:
A step of receiving a set motor torque,
A correction step in which the corrected set motor torque is determined based on a result of a comparison between the set motor torque and a normal operating threshold, said corrected set motor torque varying with a correction frequency around a corrected operating value over a corrected operating range, said corrected operating value being less than the set motor torque,
An indication step in which the control motor applies the corrected set motor torque to the axis of rotation of the steering wheel

The control motor is part of a steering wheel unit of an electric power steering without mechanical link. The steering wheel unit comprises in particular said steering wheel and at least the electronic steering wheel control unit which determines in particular a torque to be felt by the driver during a steering wheel maneuver, hereinafter called the set motor torque. The set motor torque is intended in particular to make the driver feel torque information consistent with a life situation in which the vehicle is located (bending, straight line, level of grip, condition of the road surface, . . . ).

The electronic steering wheel control unit receives the set motor torque during the reception step, then corrects, in other words modifies, this set motor torque according to certain conditions, during the correction step so as to determine the corrected set motor torque.

The corrected set motor torque is the motor torque that serves as a setpoint for the control motor.

In the correction step, the set motor torque is compared to the normal operating threshold, and based on this result, the corrected set motor torque is determined.

Over the corrected operating range, corresponding to a range of set motor torque values, the corrected set motor torque varies with a correction frequency around a corrected operating value, the corrected operating value being less than the set motor torque.

In other words, for a set motor torque within the corrected operating range, the corrected set motor torque varies around the corrected operating value between a value greater than the corrected operating value and a value less than the corrected operating value.

Thus, the control motor does not provide, at least permanently, the set motor torque. The control motor provides a motor torque at least partly less than the set motor torque. The control motor exerting the motor torque directly on the axis of rotation of the steering wheel may therefore have a size smaller than if it had to provide the set motor torque completely. The control motor and the electronic control unit therefore have a small size and power consumption compared to the state of the art of control motors directly exerting the motor torque on the axis of rotation of the steering wheel.

The variation of the corrected set motor torque causes a vibration-like sensation in the steering wheel which, according to the applicant's findings, makes it possible to simulate a motor torque greater than that actually applied. A driver of the vehicle holding the steering wheel therefore has the impression of a resistive torque greater than that actually applied.

The subject matter of the present disclosure may also have one or several of the following characteristics, taken alone or in combination.

In some embodiments, the corrected set motor torque is less than or equal to the set motor torque.

In some embodiments, the corrected set motor torque is less than the set motor torque over the corrected operating range.

Thus, the control motor has a size smaller than a control motor that must provide the entire set motor torque. The invention makes it possible to reduce the size and electrical consumption of the control motor compared to the state of the art.

In some embodiments, the corrected set motor torque varies with a correction amplitude around the corrected operating value.

The difference between the upper value and the lower value of the corrected set motor torque for a given set motor torque corresponds to the correction amplitude.

The correction amplitude influences the way the driver feels the vibrations.

In some embodiments, the correction amplitude depends on the set motor torque and/or time.

For example, the correction amplitude increases with the set motor torque.

For example, the correction amplitude increases with the time during which the set motor torque is requested.

In some embodiments, the corrected set motor torque is equal to the set motor torque over a normal operating range.

Thus, over the normal operating range, the set motor torque is not modified.

In some embodiments, the normal operating threshold is equal to both the maximum of the normal operating range and the minimum of the corrected operating range.

The normal operating threshold is a set motor torque value that separates the normal operating range from the corrected operating range.

The normal operating threshold therefore determines from which set motor torque the correction applies.

For example, if the set motor torque is less than the normal operating threshold, the set motor torque is within the normal operating range and no correction applies. If the set motor torque is greater than the normal operating threshold, the set motor torque is within the corrected operating range and correction applies.

In some embodiments, the correction frequency depends on the set motor torque and/or time.

For example, the correction frequency increases with the set motor torque.

For example, the correction frequency increases with the time during which the set motor torque is requested.

In some embodiments, the corrected operating value depends on the set motor torque and/or time.

For example, the corrected operating value increases with the set motor torque.

For example, the corrected operating value increases with the time during which the set motor torque is requested.

In some embodiments, the method determines a torque signal based on the set motor torque.

The torque signal varies depending on the set motor torque to be indicated to the driver.

In some embodiments, the torque signal is determined based on the corrected set motor torque.

In some embodiments, the torque signal is a haptic, audible, or visual signal.

The driver thus receives information about the set motor torque via other senses.

In some embodiments, the method comprises a reset step, subsequent to the correction step, in which a steering wheel angle is determined upon detection of a movement of the steering wheel in a direction opposite to a direction having caused the correction step.

The invention does not allow the steering wheel to be blocked in rotation. Indeed, since the steering wheel is not mechanically connected to the rack, and since the corrected set motor torque is less than the set motor torque, the driver of the vehicle may continue to turn the steering wheel while the rack is in abutment, for example, or while the wheels are blocked. Thus, the driver can perform numerous turns in the same direction without causing a modification in the position of the rack. In order to avoid the driver having to repeat said numerous turns in an opposite direction before moving the rack in the opposite direction again, the method according to the invention comprises a reset step. For this, the reset step detects a counter-steering, or a change in the direction of rotation of the steering wheel, and determines the steering wheel angle coherent with the rack position.

In some embodiments, during the reset step, the steering wheel angle is determined based on a result of a comparison between the set motor torque and an abutment threshold.

The abutment threshold is the value of the set motor torque for which it is considered that the rack may no longer be displaced either because the wheels are blocked in rotation or because the rack is in abutment.

Thus, the reset step is performed, for example, only if the set motor torque is greater than the abutment threshold. In other words, only if the steering wheel angle may become incoherent with the actual position of the rack.

Another aspect of the invention concerns an electric power steering without mechanical link implementing a method according to the invention.

### BRIEF DESCRIPTION OF THE DRAWINGS

The invention will be better understood, thanks to the following description, which relates to one or several embodiments according to the present invention, given as non-limiting examples and explained with reference to the appended schematic drawings, in which:

FIG. 1 is a schematic representation of a power steering system without mechanical link;

FIG. 2 is an illustration of an evolution of a corrected set motor torque as a function of a set motor torque;

FIG. 3 is a diagram representing a correction frequency and a corrected operating value as a function of the set motor torque.

### DESCRIPTION OF THE EMBODIMENTS

Only the elements necessary for understanding the invention have been represented. To facilitate reading of the drawings, the same elements bear the same references from one figure to another.

It should be noted that in this document, the terms “right” and “left”, used to describe a direction of rotation of the wheels of a vehicle, and “clockwise” and “counterclockwise”, used to describe a direction of rotation of a steering wheel of the vehicle, refer to this direction relative to the vehicle in a forward driving situation, that is to say the direction considered by a driver positioned normally in front of the steering wheel.

The invention concerns a method for indicating a set motor torque determining a corrected set motor torque C_{mc} for a control motor M of a power steering system 1 for a vehicle 2, and more particularly for a motor vehicle 2 intended for the transport of people.

The control motor M will preferably be an electric motor, with two directions of operation, and preferably a rotary electric motor, of the brushless type. The control motor M engaging directly on an axis of rotation of a steering wheel 3, for example by means of a pinion. For example, the control motor M has a maximum motor torque of less than 5 Nm, for example 4 Nm, preferably 3 Nm. Thus, the size of the control motor M is less than 10 cm*10 cm, for example approximately 8 cm*8 cm and a current consumption should be less than 70 A.

In a manner known per se, and as can be seen in FIG. 1, said power steering system 1 comprises the steering wheel 3 on which a driver can exert a force, called «steering wheel torque». An angle θ3 and a direction of rotation of the steering wheel 3 is measured by an angle sensor 23.

The steering wheel torque T3, the angle θ3 and the direction of rotation of the steering wheel 3 are transmitted to an electronic rack control unit 20 and an electronic steering wheel control unit 21.

Said steering wheel 3 is not mechanically connected to a steering rack 6, which is itself guided in translation in a steering casing 7 fixed to said vehicle 2. In other words, the steering wheel 3 is mechanically detached from the steering rack 6. In this case, the steering system 1 comprises a steering wheel unit mechanically independent of a rack unit. In other words, a force applied to the steering wheel unit is not mechanically transmitted to the rack unit, and vice versa. The power steering system 1 is of the «steer-by-wire» type.

The steering wheel unit comprises said steering wheel 3 and at least the electronic steering wheel control unit 21 which determines in particular a torque to be felt by the driver during a maneuver of the steering wheel 3, hereinafter called the set motor torque Cₘₒ. The set motor torque Cₘₒ is intended in particular to make the driver feel a torque information consistent with a life situation in which the vehicle 2 is located (bending, straight line, level of grip, condition of the road surface, etc.). The electronic steering wheel control unit 21 slaves the steering wheel torque to the set motor torque Cₘₒ by means of the control motor M. The control motor M then exerts a motor torque on the axis of rotation of the steering wheel so that the steering wheel torque is close to or equal to the set motor torque Cₘₒ.

The rack unit comprises said rack 6 and at least the electronic rack control unit 20 which in particular controls an angular position of the rack 6 so that it is consistent with a set angular position. The set angular position is generally consistent with the steering wheel angle θ3, but it can be modified by functions of the vehicle 2 such as a trajectory tracking function or a parking assistance function of the vehicle 2.

The electronic rack control unit 20 determines a set rack torque for controlling a maneuvering motor 24 which exerts a motor torque T12 on the rack 6. In other words, the electronic rack control unit 20 slaves the angular position of the rack 6 to the set angular position by determining the set rack torque of the maneuvering motor 2.

The angular position of the rack 6 can be deduced from an angular position θ12 of the maneuvering motor 24.

Preferably, the ends of the rack 6 are each connected to a steering connecting rod 8, 9 connected to the steering knuckle of a steered wheel 10, 11 (respectively a left wheel 10 and a right wheel 11), such that the longitudinal translational movement of the rack 6 makes it possible to modify a steering angle (yaw angle) of the steered wheels 10, 11. The steered wheels 10, 11 may also preferably be drive wheels.

The maneuvering motor 24 will preferably be an electric motor, with two operating directions, and preferably a rotary electric motor, of the brushless type.

The maneuvering motor 24 can be engaged directly on the steering rack 6, for example by means of a pinion 13.

The indication method according to the invention implements a step of receiving the set motor torque Cₘₒ, then a correction step so as to obtain the corrected set motor torque C_{mc}, and finally an indication step in which the control motor M applies the corrected set motor torque C_{mc} to the axis of rotation of the steering wheel. The corrected set motor torque C_{mc} is the motor torque which serves as a set for the control motor M.

In the correction step, the corrected set motor torque C_{mc} is determined based on a result of a comparison between the set motor torque Cₘₒ and a normal operating threshold St. In other words, during the correction step, the set motor torque Cₘₒ is compared with the normal operating threshold St, and based on this result, the corrected set motor torque C_{mc} is determined.

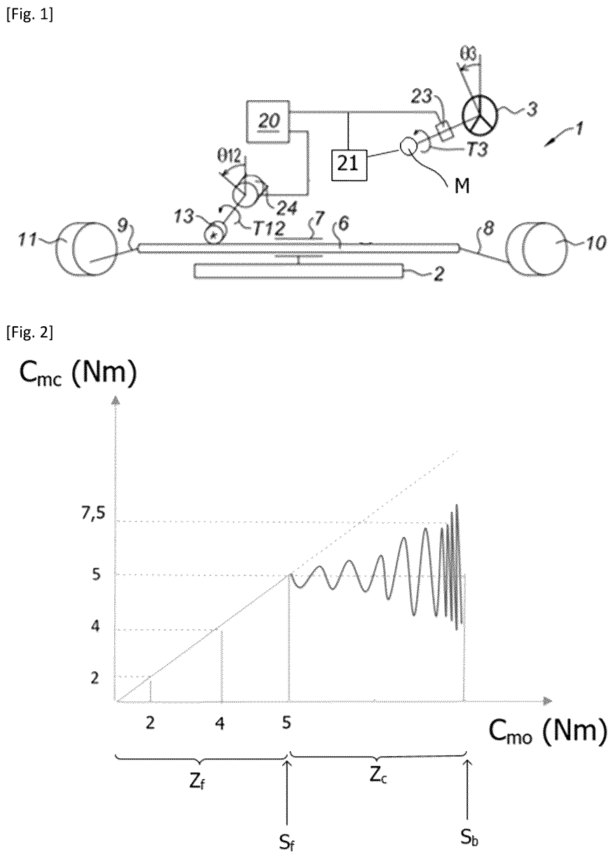

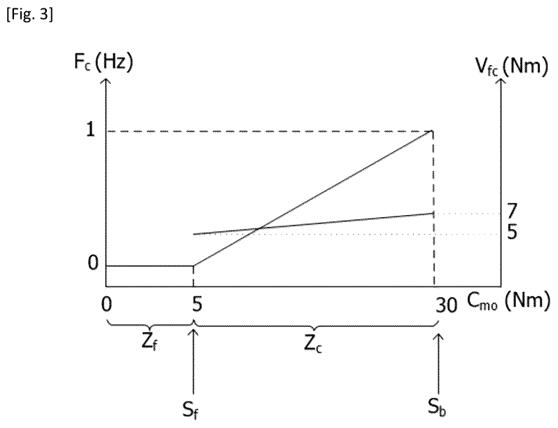

In some embodiments, and as illustrated in FIGS. 2 and 3, the normal operating threshold S_{f} is equal on the one hand to the maximum of a normal operating range Z_{f} and on the other hand to the minimum of a corrected operating range Z_{c}. The normal operating threshold S_{f} is a set motor torque value Cₘₒ which separates the normal operating range Z_{f} from the corrected operating range Z_{c}.

The normal operating threshold St determines from which set motor torque Cₘₒ a correction of the set motor torque Cₘₒ is applied.

For example, if the set motor torque Cₘₒ is less than the normal operating threshold S_{f}, the set motor torque Cₘₒ is within the normal operating range Z_{f} and no correction is applied. Thus, the corrected set motor torque C_{mc} is equal to the set motor torque Cₘₒ over the normal operating range Z_{f}.

If the motor torque set Cₘₒ is greater than the normal operating threshold S_{f}, the motor torque set Cₘₒ is within the corrected operating range Z_{c} and a correction is made by the electronic steering wheel control unit 21.

Over the corrected operating range Z_{c}, the corrected set motor torque C_{mc} varies over time with a correction frequency Fc around a corrected operating value V_{fc}.

In some embodiments, the correction frequency Fc depends on the set motor torque Cₘₒ as is illustrated in FIG. 2 or 3 and/or time.

In FIGS. 2 and 3, the correction frequency increases with the set motor torque.

In some embodiments, the correction frequency Fc increases with the time during which the set motor torque Cₘₒ is requested.

The corrected operating value V_{fc} corresponds to the torque value around which the corrected set motor torque C_{mc} oscillates. The corrected operating value V_{fc} is selected to be lower than the set motor torque Cₘₒ.

In some embodiments, the corrected operating value V_{fc} depends on the set motor torque Cₘₒ and/or time.

For example, the corrected operating value V_{fc} increases with the set motor torque Cₘₒ as shown in FIG. 3.

For example, the corrected operating value Vic increases with the time during which the set motor torque Cₘₒ is requested.

In some embodiments, the corrected set motor torque C_{mc} varies with a correction amplitude around the corrected operating value V_{fc}.

The difference between the upper value and the lower value of the corrected set motor torque C_{mc} for a given set motor torque Cₘₒ corresponds to the correction amplitude.

The correction amplitude influences the way the driver feels the vibrations.

In some embodiments, the correction amplitude depends on the set motor torque Cₘₒ and/or time.

For example, the correction amplitude increases with the set motor torque Cₘₒ.

For example, the correction amplitude increases with the time during which the set motor torque Cₘₒ is requested.

In some embodiments, the corrected set motor torque C_{mc} is less than or equal to the set motor torque Cₘₒ.

In some embodiments, the corrected set motor torque C_{mc} is less than the set motor torque Cₘₒ over the corrected operating range Z_{c}.

Thus, the control motor M does not provide, at least permanently, the set motor torque Cₘₒ. The control motor M provides a motor torque at least partly lower than the set motor torque Cₘₒ. Thus, the control motor M has a smaller size than a control motor that must provide the entire set motor torque Cₘₒ. The invention makes it possible to reduce a size and an electrical consumption of the control motor M and of the electronic control unit compared with the state of the art of a control motor exerting the torque directly on the axis of rotation of the steering wheel.

The variation of the corrected set motor torque C_{mc} causes a vibration-like sensation in the steering wheel 3 which, according to the applicant's findings, makes it possible to simulate a greater motor torque than that actually applied. A driver of the vehicle holding the steering wheel 3 therefore has the impression of a greater resistive torque than that actually applied.

However, the corrected set motor torque C_{mc} does not allow the steering wheel to be blocked in rotation. In other words, the driver, despite the felt vibrations, can continue to turn the steering wheel 3 indefinitely in one direction without changing the position of the rack 6. In order to avoid the driver having to make numerous turns in an opposite direction before moving the rack 6 in the opposite direction again, the method according to the invention comprises a reset step.

The reset step following the correction step determines the steering wheel angle θ3 upon detection of a movement of the steering wheel 3 in a direction opposite to a direction that caused the correction step. In other words, the reset step detects a counter-steering, or a change in the direction of rotation of the steering wheel 3, and determines the steering wheel angle θ3 consistent with the position of the rack 6.

In some embodiments, during the reset step, the steering wheel angle θ3 is determined based on a result of a comparison between the set motor torque Cₘₒ and an abutment threshold S_{b}.

The abutment threshold S_{b} is the value of the set motor torque Cₘₒ for which it is considered that the rack 6 can no longer be moved either because the wheels 10, 11 are blocked in rotation or because the rack 6 is in abutment.

Thus, the reset step is only performed, for example, if the set motor torque Cₘₒ is greater than the abutment threshold S_{b}. In other words, only if the steering wheel angle θ3 can become inconsistent with the actual position of the rack 6.

The method also determines a torque signal that depends on the set motor torque Cₘₒ. This torque signal comes in addition to the corrected set motor torque C_{mc} indicate to the driver the set motor torque Cₘₒ that should be felt.

In some embodiments, the torque signal is determined based on the corrected set motor torque C_{mc}.

In some embodiments, the torque signal is a haptic, audible, or visual signal.

The driver thus receives an information about the set motor torque via other senses.

Although the present invention has been described with reference to specific embodiments, it is obvious that modifications and changes may be made to these examples without departing from the general scope of the invention as defined by the claims. In particular, individual features of the various illustrated/mentioned embodiments may be combined in additional embodiments. Therefore, the description and drawings should be considered in an illustrative rather than restrictive way.

It is also obvious that all the features described with reference to a method are transposable, alone or in combination, to a device, and conversely, all the characteristics described with reference to a device are transposable, alone or in combination, to a method.

1. A method for indicating a set motor torque determining a corrected set motor torque for a control motor of an electric power steering without mechanical link, said control motor receiving the corrected set motor torque and exerting a motor torque on a rotation axis comprising a steering wheel, said method being implemented by an electronic steering wheel control unit and comprising:
a step of receiving a set motor torque,
a correction step in which the corrected set motor torque is determined based on a result of a comparison between the set motor torque and a normal operating threshold, said corrected set motor torque varying with a correction frequency around a corrected operating value over a corrected operating range, said corrected operating value being lower than the set motor torque,
a reset step, subsequent to the correction step, in which a steering wheel angle is determined upon a detection of a movement of the steering wheel in a direction opposite to a direction having caused the correction step,
an indication step in which the control motor applies the corrected set motor torque to the steering wheel rotation axis.

2. The indication method according to claim 1, wherein the corrected set motor torque varies with a correction amplitude around the corrected operating value.

3. The indication method according to claim 2, wherein the correction amplitude depends on the set motor torque and/or on time.

4. The indication method according to claim 1, wherein the corrected set motor torque is equal to the set motor torque over a normal operating range.

5. The indication method according to claim 4, wherein the normal operating threshold is equal on the one hand to the maximum of the normal operating range and on the other hand to the minimum of the corrected operating range.

6. The indication method according to claim 1, wherein the correction frequency depends on the set motor torque and/or on time.

7. The indication method according to claim 1, determining a torque signal as a function of the set motor torque.

8. The indication method according to claim 1, wherein during the reset step, the steering wheel angle is determined as a function of a result of a comparison between the set motor torque and an abutment threshold.

9. An electric power steering without mechanical link implementing a method according to claim 1.
